(19) United States
(12) Patent Application Publication
(10) Pub. No.: US 2008/0289905 A1
(43) Pub. Date: Nov. 27, 2008

(54) Retrieval and fall arrest system for manhole applications

(76) Inventors: Bradley A. Pelsue, Denver, CO (US); Edward J. Inman, Denver, CO (US); Timothy G. Peters, Boulder, CO (US); Christopher J. Duke, Denver, CO (US); Mark R. Niksic, Conifer, CO (US)

Correspondence Address: Thomas H. Young, Esq.;Thomas H. Young PC, 5500 Hawthorn Cir., Greenwood Village, CO, 80121, US

(21) Appl. No.: 12/151,018

(22) Filed: May 2, 2008

Related U.S. Application Data
(60) Provisional application No. 60/927,210, filed on May 2, 2007.

(51) Int. Cl. A62B 1/08

(52) U.S. Cl. 182/236

(57) ABSTRACT

A foldable hoist, fall-arrest and recovery system to be used in connection with a rectangular manhole guard having vertical posts at four corners of the guard including an upper structure having four elongated support members forming a pyramid shaped structure with the base of each of the support members being securely mounted to the top of a post on the manhole guard and the other ends of the support members being pivotally connected to an apex so that the upper structure can be folded for storage and shipment when disconnected from the base and means connected at the apex for raising and lowering workers and/or cargo into and out of the manhole or for arresting the fall or recovering a worker.

This application claims the benefit of U.S. provisional patent application Ser. No. 60/927,210, filed on May 2, 2007, which is incorporated by reference herein.

### I. FIELD OF THE INVENTION

The invention relates to the field of manhole safety protection systems, in particular to manhole guards and to devices for transporting materials and personnel through the manhole into an underground vault. In particular, the invention relates to devices for safely arresting the fall of a worker entering an underground vault or confined space and for recovering a worker from an underground vault or confined space.

### II. BACKGROUND OF THE INVENTION

For a number of reasons, the utility “infrastructure” for urban society is implemented in significant part using underground facilities. Among other things, electric, gas, telecommunication and water services are distributed in part underground. Sewer systems remove surface waste water via underground conduits. To service this infrastructure, utility personal access the underground facilities through “manholes” at the interface with the ground surface.

During the servicing of underground utility systems, both the utility personnel and the public in general are subjected to a number of safety concerns. Personnel in the underground vault may be subjected to noxious or toxic fumes and may otherwise have an inadequate supply of fresh air. Materials and tools need to be safely transported to and from the surface without injury to personnel, and personnel may need to be recovered from the vault in the event of injury or other circumstances. Workers need to be able to successfully move to and from the surface into the vault without injury even if there is an inadvertent “fall,” and facilities need to be provided for promptly and safely recovering a worker who becomes injured or incapacitated while underground. The public needs to be protected from accidentally falling into an open manhole.

These safety concerns have been addressed in a number of regulations, standards and practices. Blowers are used to provide fresh external air through the manhole into the vault using flexible, reinforced air conduits. Temporary, portable manhole “guards” are placed around open manholes to prevent passerbys from accidentally falling in or tripping over the opening. Various forms of hoists and fall protection systems have been devised to move personnel and material into and out of the underground vault through the manhole.

The various forms of manhole hoists and fall arrest systems that have been employed in the past have met with only limited success. Among other things, prior art hoists have not included a manhole guard or have not cooperated well with the guard thereby interfering with access of personnel and materials through the manhole. Prior art hoists have failed to provide adequate load capacity or fall arrest protection. As a result, there is a significant need for improvement in these devices.

One form of hoist used in the industry is a tripod arrangement employing a winch and a pulley suspended from the apex of its three legs whose “feet” rest on the ground surface. (See, e.g., U.S. Pat. No. 4,660,679, issued on Apr. 28, 1987, to Ostrobrod, and No. 4,589,523, issued on May 20, 1986, to Olson.) These hoists do not include a manhole guard, and they do not interact well with typical manhole guards thereby interfering with a worker's easy entry and exit via the manhole. When used with a manhole guard, the narrow footprint of the legs is constrained thereby limiting the stability and lifting capacity of these hoists.

Another system employs a base with an H-frame footprint that rests on the ground and contains a single upwardly extending arm to support a pulley and winch. (See, U.S. Pat. No. 4,838,439, issued on Jan. 13, 1989, to Baziuk.) Unfortunately, the cross-bar in the “H” extends over a portion of the manhole opening thereby interfering with and limiting the passage of personnel, materials and tools into and from the underground vault. In addition, the use of a single upwardly extending arm also significantly limits the lifting capacity of the hoist. (See also, U.S. Pat. No. 6,899,238, issued to Austin et al. on May 31, 2005, showing a similar one-armed hoist device.)

Attempts have been made to improve these hoist systems, but the “improvements” have also met with only limited success. For example, other H-frame systems have been described and employed in which a horizontal cross-bar that supports the pulley is supported by oppositely facing handrails on the manhole guard. (See, e.g., U.S. Pat. No. 5,022,489, issued to Sauber on Jun. 11, 1991.) While these systems do not completely obscure the manhole opening, they still restrict access by personnel, because the handrail of the manhole guard is usually between waist and chest level on a typical worker. Thus, the crossbar and pulley still interfere with a worker who must crouch down or even sit to access or leave the manhole. Also, the lifting capacity of these devices is limited by the fact that the load is supported from the single horizontal crossbar which itself rests on two of the handrails of the manhole guard. Most manhole guards, however, are designed to be light-weight portable “shields”—not load bearing structures.

Finally, U.S. Pat. No. 5,725,070, issued to Eldred on Mar. 10, 1998, describes another system that attempts to provide a combination manhole guard and hoist. The Eldred device is a substantial structure incorporated as an integral part of a vehicle trailer. Such a device is much more expensive than the other prior art systems. It can only be moved from site to site as an attachment to a vehicle. It is difficult to align over a manhole, and its application is limited to manholes that are not impeded vis-à-vis other structures, e.g., walls, curbs, and/or parked vehicles.

Clearly there is a need for a simple portable device that: (a) can act as a guard around a manhole opening; (b) can provide significant lifting capability; and (c) can provide fall arrest and recovery capability, all without interfering with movement of personnel and materials into and out of the manhole.

### III. SUMMARY OF THE INVENTION

The present invention provides an integrated, portable manhole guard and manhole hoist that does not obstruct passage of personnel and materials through the manhole and provides fall arrest and high load bearing lift capacity. The device comprises a separately foldable base constituting the essential structure of the manhole guard and a separately foldable top portion comprising the hoist and fall arrest support structure.

The base can be folded into a folded position for shipment and storage separately from the top. In the expanded position, the base comprises three sides of a rectangle forming the guard structure to keep people from inadvertently encountering the manhole and an open side permitting the entry and exit of personnel and materials. This open side can be closed by various temporary means so that inadvertent access to the manhole is prevented on all sides. The base also includes “locking” means to align the base for installation of the top portion, to provide stability for the erected base and to prevent the base from inadvertently folding from the erected position during use.

The top portion includes four support “members” or “legs” that can pivot at an apex to form a folded configuration for shipment and storage and can be expanded into a pyramidal configuration for use with the base. In the expanded configuration, each of the four support legs of the top portion is securely attached at its bottom end, i.e, “foot,” to the top of the respective corner of the base. In the expanded configuration, the support legs extend upward—like architectural buttresses—and meet at an apex. The apex contains attachment means from which a pulley can be suspended to facilitate the movement of a flexible, rope, cable or other means for raising and lowering a worker or material and equipment through the manhole into the vault. A winch, preferably of a ratchet variety, can be attached to one of the four support legs to apply appropriate force to move the rope or cable. In addition or as an alternative, a device can be attached to the apex of the upper portion from which a safety lanyard can be deployed to assist in arresting the fall of a worker as he/she is raised or lowered through the manhole.

The integral manhole guard and hoist of the present invention provides the following advantages, among others:

(a) It prevents members of the public from accidentally falling into or tripping over the manhole.

(b) It minimizes obstruction to workers and materials as they enter or leave the manhole.

(c) It is easily moved by a single person in two foldable, light weight sections.

(d) It is easily and rapidly erected into a manhole guard and hoist by a single individual.

(e) It is structurally sound thereby providing larger load bearing hoist capabilities than devices in the prior art.

(f) It is OSHA compliant when properly utilized as a fall arrest or confined space retrieval device.

### IV. BRIEF DESCRIPTION OF THE DRAWINGS

The present invention may be more readily described and understood by reference to the accompanying drawings in which:

FIG. 1 is a perspective view of the device of the present invention showing the arrangement of the upper hoist structure and the lower guard as assembled with one another and including a hand winch and pulley system.

FIG. 2 is a perspective view of the base portion or frame in the erected position.

FIG. 3 is a perspective view of the base in the folded position.

FIGS. 4A (disassembled) and 4B (assembled) depict an embodiment employing adjustable “feet” for leveling the guard and hoist.

FIG. 5 is a view of the base with one form of locking system as shown in FIG. 1.

FIG. 6 is a view of the base with a second form of locking system.

FIG. 6A shows the components of the locking system separately from the guard.

FIG. 7 is a perspective view of the top portion or frame in the erected position separate from the base.

FIG. 8 is a perspective view of the upper portion in the folded position.

FIG. 9 is a detail of the apex of the upper structure shown in FIGS. 7 and 8.

FIG. 10 is a view of the pin system for locking the top portion to the base at each corner.

FIG. 11 is a view of the top structure with the winch mounted in place.

FIG. 12 is a view showing the details of the winch mounting. It is viewed from the inside of the top structure and the gusset has been removed to show the detail of the mounting.

FIG. 13 is a detailed view of a typical hand winch as mounted and used in the invention.

FIG. 14 is a detailed view of the hand winch with a cleat installed in a preferred embodiment of the invention.

FIG. 14A (perspective view), 14B (front end view), 14C (side view) and 14D (top view) depict a cleat used in rapid attachment of a cable or rope to a winch.

FIG. 15 depicts the apex of the upper structure in a preferred embodiment with both a pulley and retractable fall arrest device, i.e., safety lanyard, installed.

FIG. 16 depicts the use of the device to raise and lower a worker through the manhole.

FIG. 17 depicts the use of the device in a situation where the cable is not needed to secure the worker at a fixed vertical height in the vault and the user desires to work without constraint from attachment to the winch.

FIG. 18 depicts the transition of the device from the cable arrangement shown in FIG. 17 to an arrangement for rapid rescue of the worker using a winch-mounted cleat as shown in FIG. 14.

### V. DETAILED DESCRIPTION OF THE INVENTION AND CERTAIN PREFERRED EMBODIMENTS

The invention is now described with reference to preferred embodiments as depicted in the drawings and described herein.

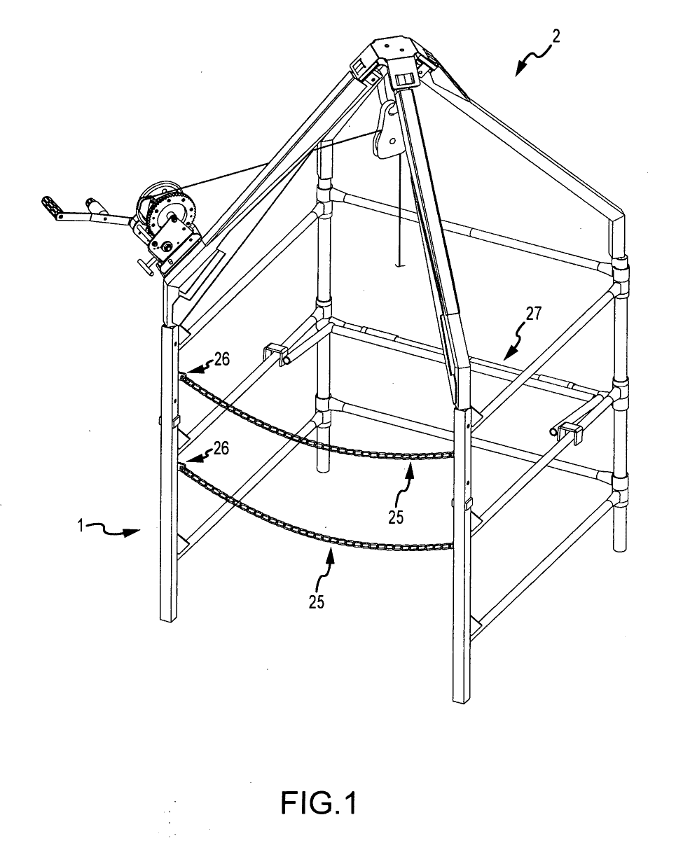

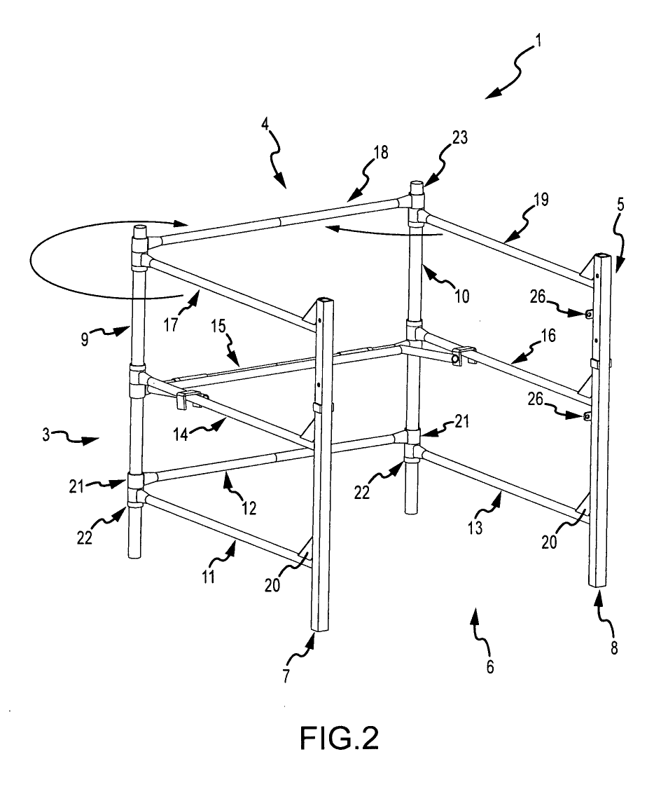

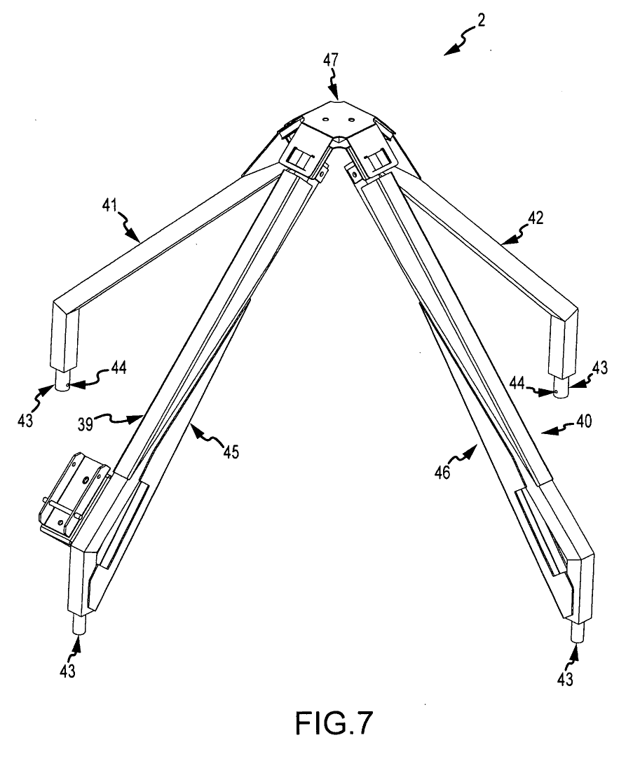

FIG. 1 depicts one embodiment of the present invention in an erected and assembled condition ready for use. As illustrated in FIGS. 1, 2 and 7, the present invention includes a lower portion or base 1 and an upper portion 2 which is mounted on the base. The lower portion shown in FIG. 2 contains the essential features of a typical manhole guard. The upper portion shown in FIG. 7 contains the features of the hoist and also serves as part of the guard. FIG. 1 shows the upper portion or hoist 2 mounted on the lower portion 1.

The term “hoist” as used herein should not be construed to mean a device for raising and lowering things, i.e., tools, parts or equipment, exclusively. Indeed, the principal use of the “hoist” is to raise and lower individual workers into and out of the vault. In many instances, the hoist may also be used to position the worker at the proper vertical location in the vault where work is to be performed. This occurs when the worker cannot stand on a floor or ledge to access the work and it is impossible to use a ladder or scaffold to reliably reach the work area. In those instances, the hoist is used both to raise and lower the worker and to maintain the worker in position while he is working.

The invention as shown in the drawings is constructed so that the device is “man-rated,” in the sense that it is OSHA compliant for fall arrest or confined space retrieval of a worker. To achieve this goal, the device should be dedicated to the exclusive use of supporting a person. It should not be simultaneously used for supporting a person and for raising, lowering or otherwise supporting cargo or for supporting other persons. Thus, the hoist can be used for raising and lowering work materials or raising and lowering a person, but it should not be used for both simultaneously.

The device depicted in the drawings and described herein has a load rating of at least 350 pounds. The load bearing capability can be increased or decreased by using different materials or material thicknesses, different winches, cables, etc. Those types of modifications are deemed within the skill of the art and are not described or depicted herein.

For convenience, the features of the lower portion or base 1 are referenced in detail on FIG. 2 where it is shown separately. As shown in FIG. 2, the lower or base portion of the invention includes three sections 3, 4, and 5 which form three sides of a rectangle (when viewed from above). The other side 6 is open and permits entrance and egress for the work area. The lower portion includes two front posts 7 and 8 and two back posts 9 and 10. Typically the posts are hollow metal pipe. Although the posts could take different configurations, preferably they extend in a vertical direction so that the load forces transmitted from the upper portion are transmitted vertically to the ground without torsion or lateral movement. The posts forming the three sides are connected to one another by a series of lower rails 11, 12 and 13, upper rails 17, 18 and 19, and middle rails 14, 15, and 16. The rails can be made of the same metal pipe as the posts, typically 6061 T6 structural aluminum.

The side rails are connected to the front posts by reinforced welds, such as 20 so that the rails are in a fixed position relative to the posts, i.e., they do not slide up and down and they do not rotate. Similarly, the back rails are fixed to the back posts with tubular fittings 21 that are also welded in place. In a preferred embodiment, the upper side rails 17, 18, and 19 are not attached to the four posts at the top, but are attached below the top of each post. This leaves each post with a segment of exposed pipe 23 at the top of the post on which the upper portion of the invention can be securely mounted.

In contrast the side rails 11, 14 and 17 on one side and 13, 16 and 19 on the other are connected to but not fixed to the back posts 9 and 10. For example tube 22 encircles back post 10, but is not fixed to the back post. This permits the sides to pivot horizontally around the back posts, so that the two sides and the back can be folded for storage and transportation. The rotation of the sides relative to the back is depicted by arrows in FIG. 2. In this instance, both sides are rotated in a clockwise direction. Similarly, the folding could be accomplished by rotating both sides in the opposite direction. Rails 12, 15 and 18 connecting the two rear posts are vertically offset from the respective lower, middle and upper rails on each side, so that the sides can be folded into a position parallel with the back.

One skilled in the art would appreciate that it is possible to use other combinations of hinges or structurally equivalent features to permit the two sides and back to fold relative to one another. It is also possible to design the base so that the two sides and the back are separate sections that are attached to one another in the field and are disassembled after use. Or the sides and back may be permanently welded together in a fixed configuration that cannot be folded or disassembled. However, the unitary, but foldable, structure is preferred, since there are no loose pieces, and the device can be quickly and easily transported and erected for use.

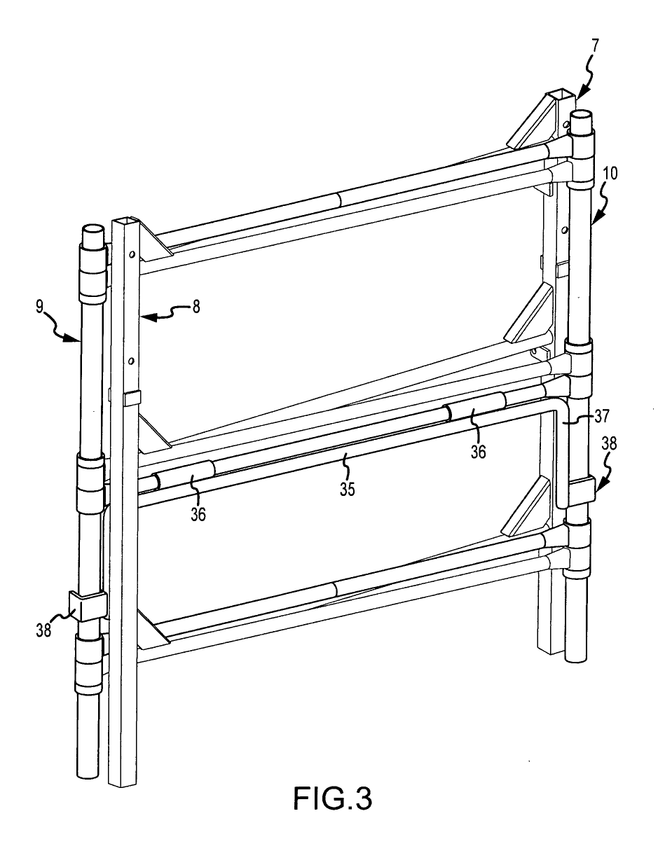

FIG. 2 illustrates a base or lower portion of the invention in the erected position. FIG. 3 illustrates the same base in the folded position for shipment and storage. Folding is accomplished by pivoting the sides relative to the back so that the two sides and back are generally parallel to one another. Although not depicted in the drawings, the base can include a feature, such as a hook and eye or strap to hold the sides and back in the parallel, folded position to facilitate handing. The folded base can also be inserted into a bag with appropriate handles and straps for transportation and storage.

In use, the lower portion 1 of the device of the present invention is placed on the surface around a manhole to serve as a guard and a support for the hoist. The space between the two front posts 7 and 8 defines an opening 6 that is used for entrance and egress of service personnel and materials into the area around the manhole. This opening should be closable temporarily, so that the public is precluded from any accidental access to the manhole. This can be achieved by a number of means. In the embodiment shown in FIGS. 1 and 2 the front posts 7 and 8 each contain an upper and lower metal tab 25. These tabs are welded to the posts and contain a hole through which one end of a chain 25 can be attached as shown in FIG. 1. Thus, the opening between the front posts can be cordoned off by the chains. The chains can be easily removed from the tabs at one or both ends when access into the area defined by the base is required. For example, at least one end of the chain can have a link with a retractable opening, such as an “O-clip,” for locking engagement with the hole in the tab on a corresponding post.

Many other forms of “gates” structures or temporary barriers can be employed in connection with the front posts to permit temporary access for authorized service personnel and materials, but to otherwise serve as barriers to the public. The system of chains and tabs shown in the drawings is a preferred method, because it is effective and light in weight.

There are several other optional, but preferred, features of the base. One of these is the provision of “feet” for leveling the four posts. This helps assure that the posts are in a vertical position so that the base does not “rock” back and forth and, more importantly, that the forces transmitted by the upper portion under load are transmitted vertically and equally through the posts without torsion or lateral force.

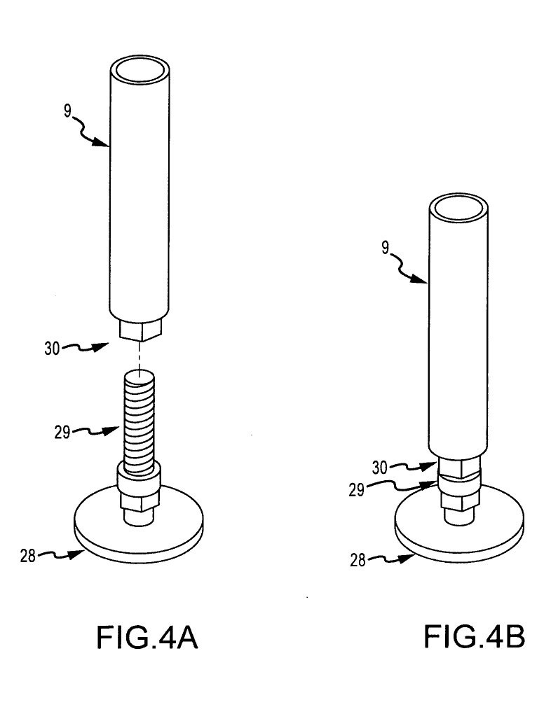

One system of providing feet to level the posts is depicted in FIGS. 4A and 4B. In general, the foot or pad 28 is attached to one end of a leg or stem 29. The stem is threaded on the outside and mates with an internally threaded sleeve 48 that fits in and is secured within a hollow post such as 9. Each post contains such an arrangement. By screwing the stem up or down inside each post, the length of that post can be effectively shortened or extended thereby enabling the base to be leveled. In addition, the stem can be attached to each foot by a ball and socket arrangement. This permits rotation of the foot with respect to the stem so that the two do not necessarily have to be perpendicular to one another. This permits the foot to adapt to the orientation of the ground surface where it is located and assists in distributing the load forces through the post to the ground.

Another desirable feature is the use of a “locking mechanism” to fix the sides and back in a rectangular relationship when the base is erected. This serves to prevent inadvertent pivoting of the sides relative to one another and possible collapse of the base. It also serves to align the four posts relative to the top portion so that the top and base can be more easily connected and assembled together. Finally, the locking mechanism provides structural support on the sides and “back” (i.e., the middle side) of the base when a load is applied. Again, the locking mechanism can take a number of forms. Two preferred embodiments are illustrated in the drawings.

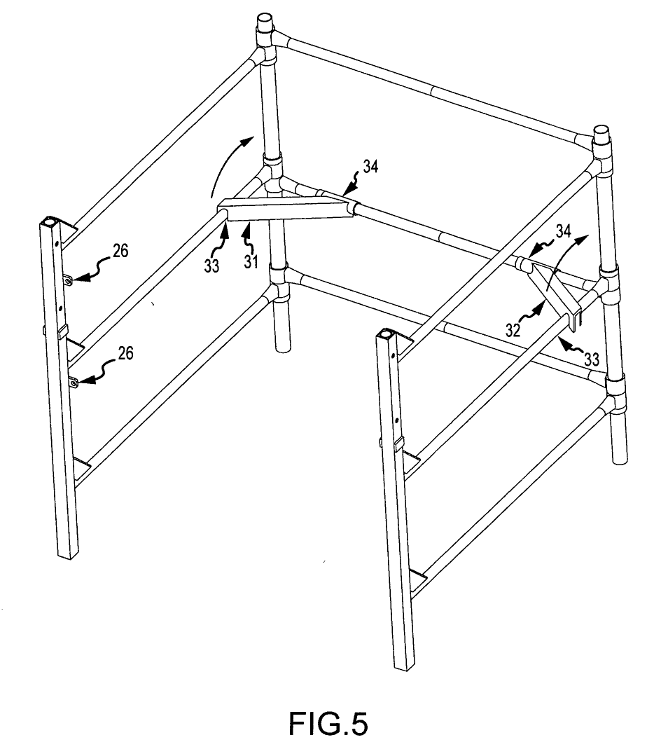

FIG. 5 illustrates one form of locking mechanism comprising diagonal struts 31 and 32. As depicted in this figure, each strut is formed from an appropriate length of channel shaped metal. The walls of the channel are cut diagonally at each end of the strut in an appropriate width to form locking features 33. When the sides of the bottom portion have been folded out and placed in the erected position, each strut is rotated around hinge 34 on back bar 15 so that the locking feature 33 on one end snaps into secure relationship with one of the side rails. Preferably, the middle rails on the side and back are used as depicted, although the locking mechanism could also be employed on rails at other levels. Accordingly the side rails cannot move or move only slightly relative to the back rails thereby fixing the bottom portion or guard into a fixed position. Thus, the base portion of the device will not fold or collapse should a passerby accidentally brush or fall against the manhole guard. In addition, with the struts in place, all posts are in the proper alignment for easily mounting the upper portion of the device.

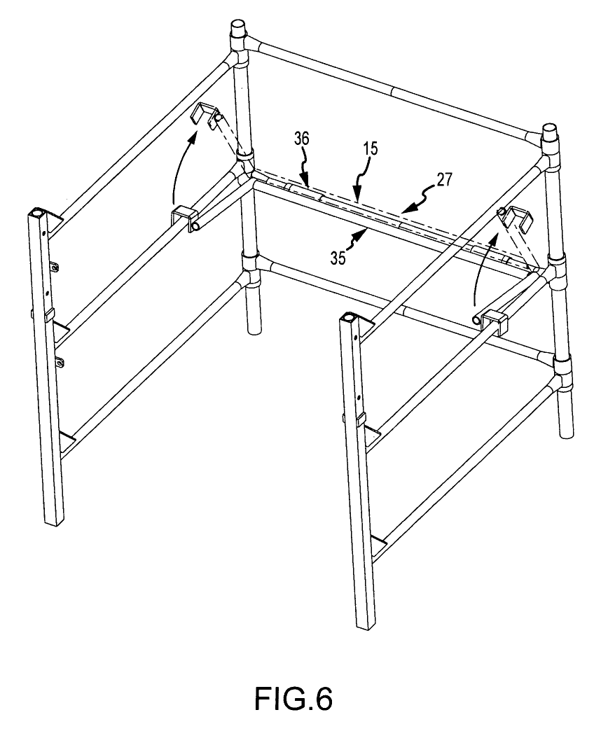

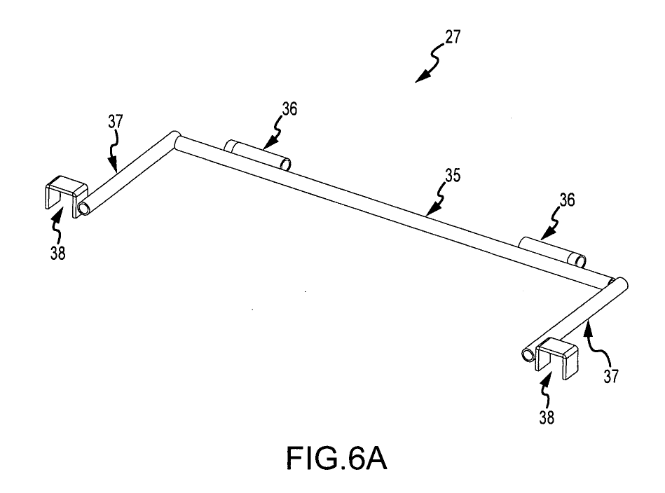

FIGS. 6 and 6A illustrate a preferred locking mechanism. FIG. 6A is a detail of the locking mechanism itself, and FIG. 6 shows the locking mechanism assembled as part of the base. The locking mechanism comprises a bar 35 that is mounted parallel to and from back rail 15 via hinges 36. Attached to each end of the bar are arms 37 that extend outwardly perpendicular to the back rail 15. Each arm contains a bracket or channel locking bracket or feature 38. When the sides of the bottom portion have been folded out and placed in the erected position, the locking bar is rotated downward (in the direction opposite to the arrows shown in FIG. 6) so that each of the locking features on the arms snaps into a secure relationship with one of the side rails. Again, this locks the sides of the base into proper relationship with the back to prevent inadvertent folding or collapsing and to align the four posts for mounting of the upper portion 2 of the device of this invention. When the work has been completed and the base needs to be folded up, the locking mechanism is rotated upward as illustrated by the arrows in the drawing. The arrangement of the locking mechanism in the folded base is shown in FIG. 3.

Finally, it may be desirable to employ a “kick plate” on the lower portion of the guard to assist in keeping road debris such as stones, pebbles and trash from entering the working area and the manhole itself. As known in the prior art, the kick plate can consist of fabric or other material attached to the lower rail and extending downward to the ground.

Several factors should be considered in designing a base for the present invention to achieve desired load strength and stability. As depicted in the drawings, a preferred embodiment of the invention is open in the front for easy access into and out of the guard enclosure. However, the absence of reinforcing sidebars, such as those used on the sides and the back of the guard presents challenges to the structure. These issues can be offset in several ways. First, the base can be reinforced at the front by using heavier load bearing posts. As shown, for example, in FIGS. 1 and 2, the front posts 7 and 8 have a square cross-section and are made of thicker metal than posts 9 and 10 at the back of the guard. The front posts 7 and 8 cooperate with heavier, reinforced legs 39 and 40 on the front portion of the top 2 to provide strength and stability as described later. In addition, in designs for higher load applications, e.g., loads greater than 350 lbs up to 1800 lbs or even higher) it is desirable to permit the sides of the base to flare outward slightly from a 90 degree relationship with the back to provide a wider footprint for distribution of vertical load forces. To accommodate, but restrict this, features 38 on the locking mechanism shown in FIGS. 6 and 6A may be widened by several inches to permit outward movement of the sides by that amount, but no more.

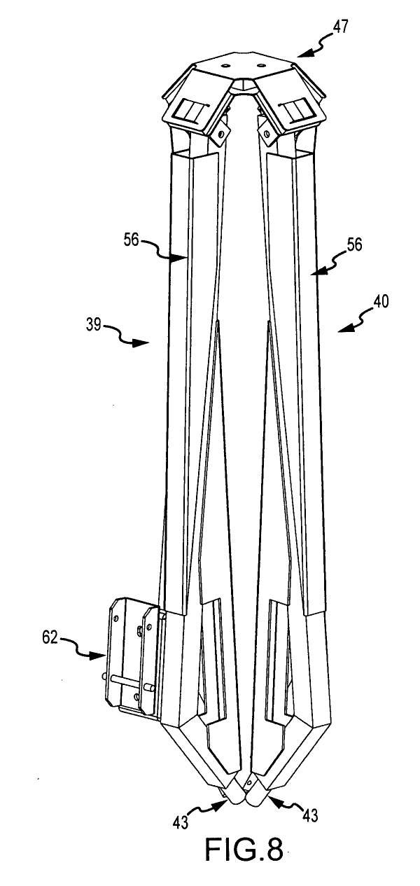

For convenience, the features of the upper portion or hoist 2 are referenced in detail on FIG. 7. This upper or top portion 2 of the invention constitutes the structure for supporting the hoisting, fall arrest and recovery features of the invention. The upper portion of the invention includes four support legs 39, 40, 41 and 42, which are pivotally joined at an apex 47. This upper frame 2 has a pyramid shape when erected as illustrated, for example, in FIGS. 1, 7 and 11. FIG. 8 illustrates the same upper frame in the folded position for shipment and storage. Folding is accomplished by pivoting the buttresses or support legs at the apex so that all four supports are generally parallel to one another. Although not depicted in the drawings, the top portion 2 can include a locking mechanism to hold the four support legs in the parallel, folded position to facilitate handing. The folded top portion can also be inserted into a bag with appropriate handles and straps for transportation and storage.

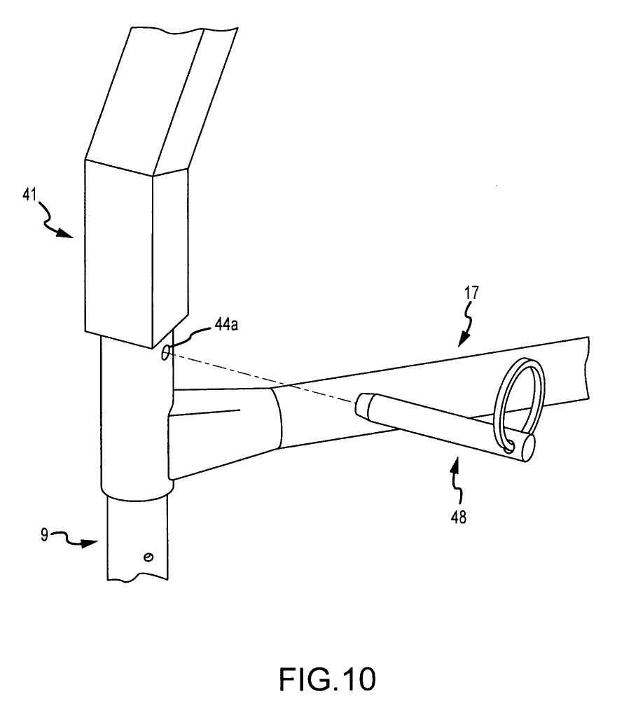

As illustrated in FIGS. 7 and 8, the base of each support leg contains an adaptor or peg 38 that mates with the top of each post 7, 8, 9 and 10 of the base frame 1. FIG. 10 shows the details of the mating relationship between a leg 41 of the upper frame and the top of a post 9 on the base frame 1. The peg 38 extends downward into the open end of the post 9, and the remainder of the leg 41 rests on the top of the post. The post 9 also contains a hole 44a that runs through both, i.e., opposite, walls of the hollow pipe 9 and which is aligned with holes 44 in the peg. A locking pin 48 is passed through the holes in the post 9 and in the peg 43 when they are properly aligned. Preferably, the end of the pin is attached by a tether to the post, so that it will not become lost and is easily located when needed.

Alternative means can be employed to connect the top 2 and base portions to one another. For example, a tube with an internal dimension wider than each post on the base can be attached at the end of each leg of the upper frame so that the tube extends over and around the top of each post on the base. A pin or locking mechanism can be used, but is not required if the tolerances between these mating tubes are sufficiently tight and the top of each post on the base extends sufficiently far upward into the tube.

Alternatively the top portion can be oriented and locked to the base by an adaptor that fits on and preferably around a portion of the upper rails of the base. This embodiment may be particularly useful for adopting the upper or hoist portion 2 of the invention to a previously existing manhole guard. As noted previously, however, most manhole guards are lightweight devices intended to warn and exclude passersby and vehicles from inadvertently entering the manhole; they are not intended for structural load bearing capabilities.

Preferably, the legs of the top portion are sufficiently long so that: (1) the apex of the pyramid is high enough to minimize interference with access to the manhole and (2) the forces of a load applied downward from the apex of the pyramid will be transmitted down along the legs and vertically through the posts in the lower portion to the ground. If the legs are not sufficiently long, these results will not be achieved. Like the base, the legs in the upper portion may be made of 6061 T6 structural aluminum. Where greater strength is desired, the legs may be constructed of steel.

As noted previously, in a preferred form of the present invention, a chain is placed between the two front legs and is of a sufficient length to act as a tension member to assist in transferring force between these two legs. As noted previously, however, the strength and stability of the device can be improved by strengthening the front legs of the upper portion. Thus, as depicted in FIGS. 1, 7, and 8, the front legs 39 and 40 contain metal reinforcement, e.g., gussets, 45 and 46, on the underside to provide strength.

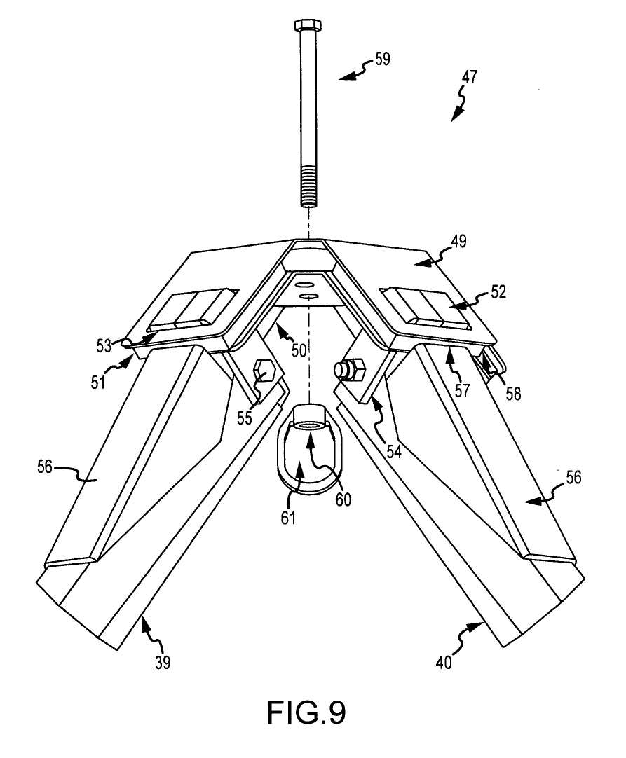

For convenience, the features of the apex 47 of the upper portion or hoist 2 are referenced in detail on FIG. 9. The tops of two of support members 39 and 40 are also shown to illustrate the relationship of the supports to the apex. The apex itself consists of upper plate 49 and lower plate 50 between which is a third plate 51 including interlocking pieces 52 which pass through cut-outs 53 on the upper plates 49 to orient the three pieces in a sturdy laminated structure. The lower plate also contains brackets 54 and nuts and bolts 55 which run through the brackets and the ends of the members 39 and 40. This allows the members or legs, such as 39 and 40, to rotate about the bolts from the erected position as shown in FIG. 9 to the folded position depicted in FIG. 8. Also attached to the upper end of each member is a plate or gusset 56, to provide structural support to the end of the member. Upper end surface 57 of each plate also acts as a “stop” in that it interacts, i.e., butts, with the lower end of the sandwich of plates 49, 50, and 52 to prevent rotation of the members upward and outward beyond that needed to position the lower ends of the members for interlocking with the top of the four posts on the base 1. Finally, at least one bolt 59 extends through the plates at the apex 47 and is secured to ring nut 60. Ring nut 60 has an opening 61 to which a pulley, retractable fall arrest lanyard, etc. can be attached with an “O-clip” or similar device. An additional bolt can be aligned in the same manner with a second ring nut so that multiple devices, i.e., both a pulley and a fall arrest lanyard can be deployed concurrently from the upper structure 2.

When the hoist is erected, the members are folded upward and outward from the position shown in FIG. 8 to the erected position shown in FIG. 9. When a load is placed on the ring nut 60, the force is transmitted downward on the apex and transmitted to the leg members 39, 40, 41 and 42. The stops 57 prevent the apex from descending downward in a manner that would move the leg members further outward.

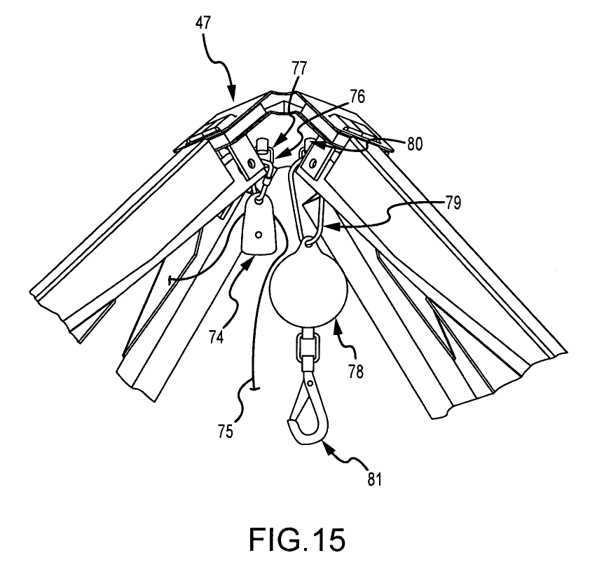

FIG. 15 shows another configuration at the apex 47 of the top frame 2 for easy use in various arrangements. Parts that are also depicted in FIG. 9 are not numbered in FIG. 15 and do not require further explanation. FIG. 15 is merely intended to represent an alternative way of mounting two devices, i.e., a pulley 74 and a retractable fall arrest lanyard 78 to the apex 47. The pulley 74 is attached via “O-clip” 76 to a ring 77 mounted in a convention manner, e.g., nut and bolt, to the end of arm 39. Similarly, the retractable fall arrest lanyard 78 is attached via “O-clip” 79 to a ring 80 mounted in the same manner to the top end of member 40. The retractable safety lanyard is illustrated in a stored manner with the O-clip 81 fully retracted. When it is desirable to raise or lower a worker both the safety lanyard and the cable 75 deployed over the pulley 74 are attached to the worker's harness. The cable provides the means to raise or control the descent of the worker. The safety lanyard as attached to the pyramid structure of the present invention will arrest the fall of the worker in the event that there is some unforeseen problem with the connection of the worker via the cable and winch. If a fall arrest rated winch is employed, the cable 75 can be attached directly to a lanyard, and the lanyard can be attached to the worker. The safety lanyards and retractable safety lanyards can be any suitable such device known in the industry.

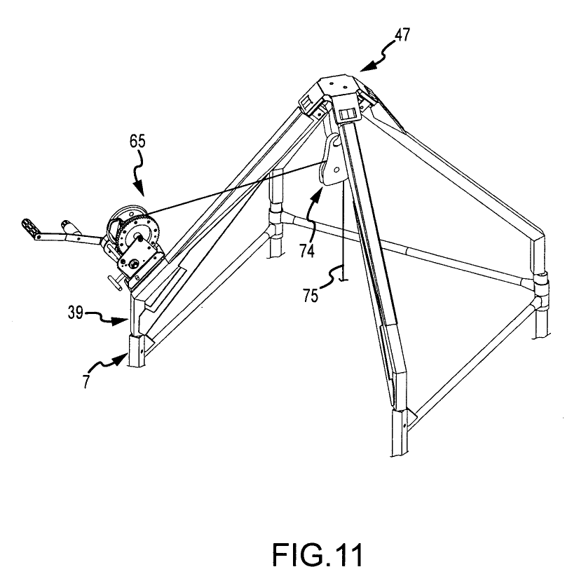

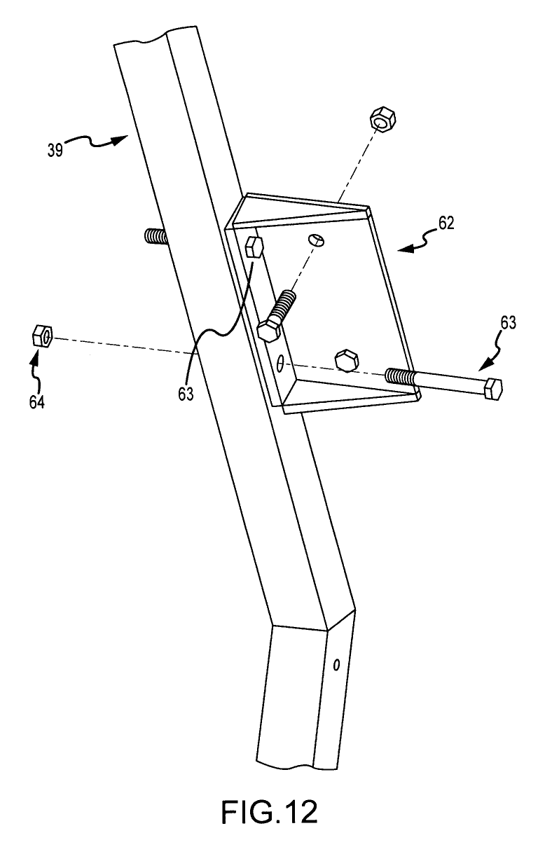

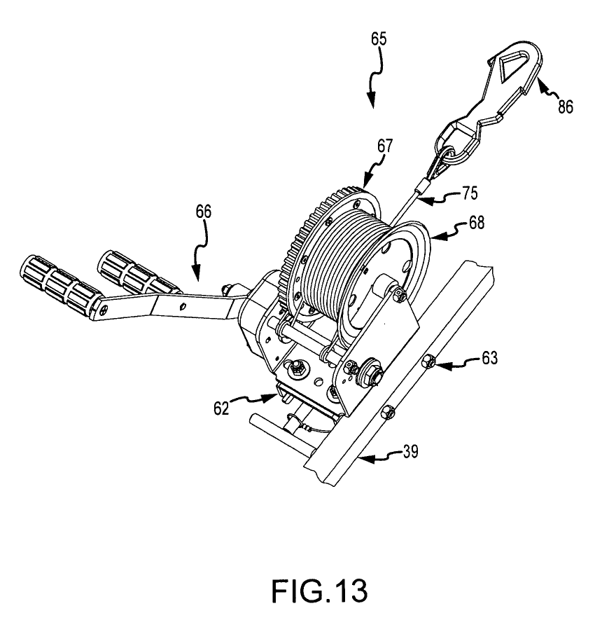

As shown in FIG. 1, the upper portion contains a plate 49 attached to one of the supports on which a winch can be mounted. FIG. 12 depicts the details of the plate and its attachment to a leg on the upper frame via a series of bolts and nuts. FIGS. 11, 12, and 13 show how the winch 65 is attached to the mounting plate 62. As depicted in FIG. 9, the winch consists of a crank arm 66 which is used to motivate gears 67 thereby providing mechanical leverage to a cable for hauling cargo or personnel through the manhole. As depicted, the crank arm can have multiple hand grips or handles so that a person operating it can apply different forces or rotate the spool at different speeds by using a different hand piece. Alternatively, the winch may have an extendable crank arm to enhance the forces manually exerted on the handle. Preferably, the winch should comply with OSHA and ANSI standards for such devices when used to raise or lift people. A suitable winch for use with rope is Model PW07R available from the T.A. Pelsue Company, Denver, Colo. In general, the winch should be a standard ratchet type winch.

In another embodiment of the invention, the winch can be mounted by a plate attached to one of the posts 7, 8, 9 or 10 on the base frame 1.

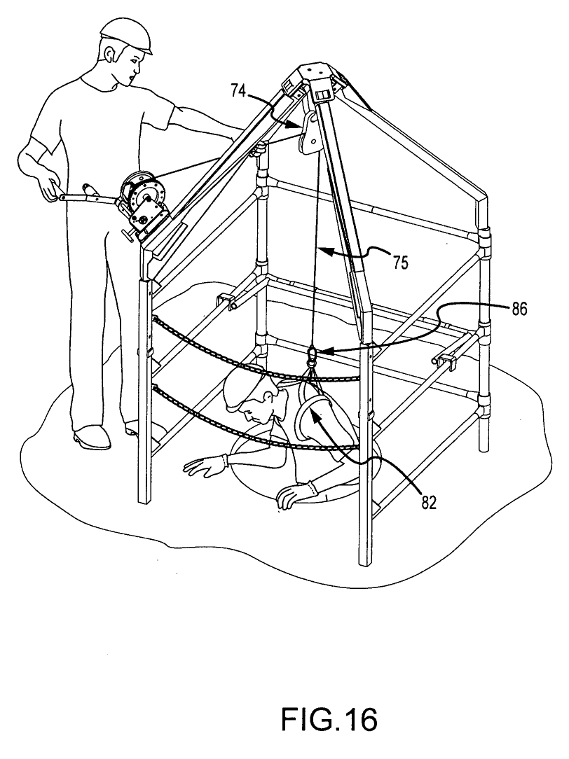

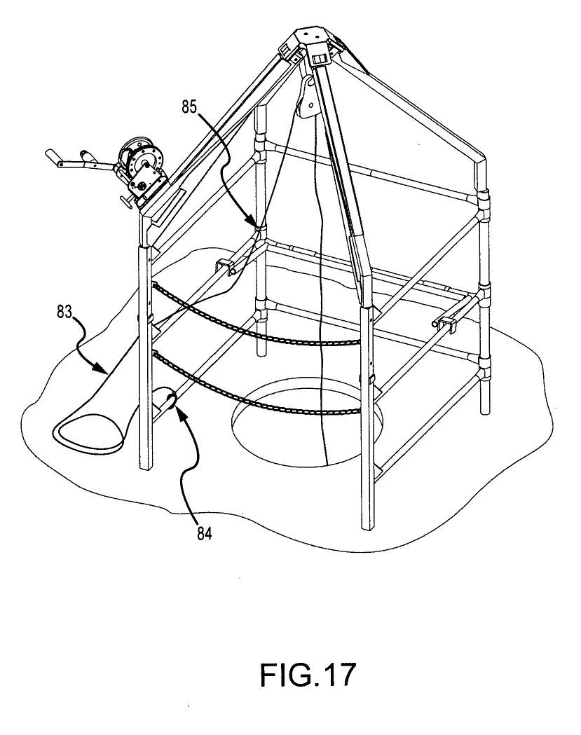

FIG. 16 shows the raising or lowering of a worker using the winch, cable and pulley. The clip 86 on the end of cable 75 is attached to the worker's harness 82 to effect vertical movement. The safety lanyard is not shown in FIG. 16 for ease of depiction. However, a retractable safety lanyard could be attached to the apex of the hoist as shown in FIG. 15. The clip on the safety lanyard would be attached to the worker's harness and would be deployed in the event that the cable was ineffective to support the worker and the worker had a sudden fall. As indicated previously, it may also be desirable to use the winch, cable and pulley to hold the worker at the desired site elevation where work is to be performed particularly, if there is no other support structure available.

Where an independent support, e.g., a ladder, is available in the vault, it is unnecessary to use the cable for vertical positioning of the worker. In this instance, some users of the system may find that being tightly secured to the cable and winch is restraining. For example, if the worker decides to descend on the latter, it would be necessary to signal another worker on the surface to “let out” additional cable to permit the descent. Some users may also perceive that being tightly secured to the winch and manhole guard is dangerous in the event that an automobile collides with the guard and moves it a significant distance. Accordingly, there may be instances where a user employing an independent support in the vault, prefers to work with the cable unattached to the winch or with a significant amount of slack in the cable to avoid the issues previously noted. FIG. 17 depicts one such configuration in which rope or cable 75 is disconnected from the winch and the excess cable 83 rests on the ground. As depicted in the drawing, the end 84 of the excess cable is temporarily looped and secured around a lower side rail on the base 1. This permits the worker to move up and down on the ladder unimpeded and without requiring assistance and ensures some degree of safety should there be a vehicle collision with the manhole guard. Although not depicted in the drawing, the worker would still be attached by a flexible fall arrest system attached to the apex of upper frame 2.

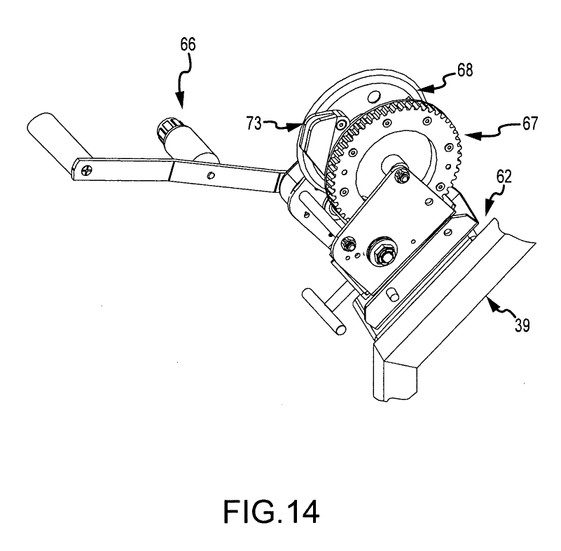

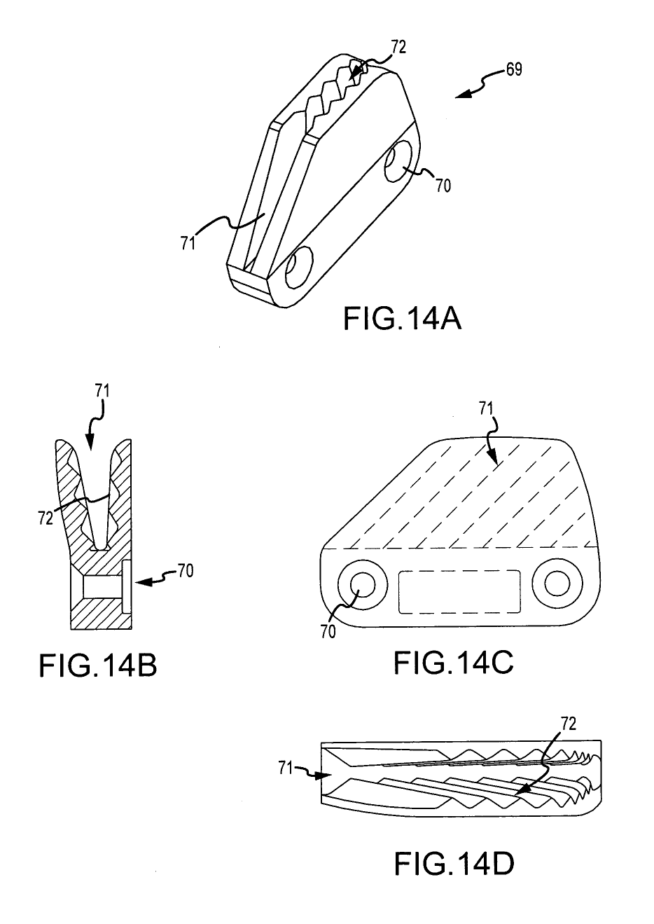

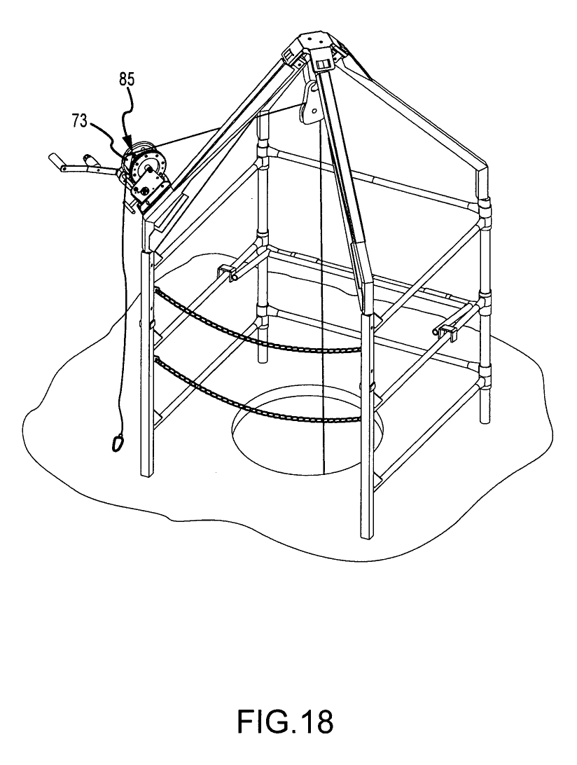

Applicants do not necessarily endorse the arrangement shown in FIG. 17. Nevertheless, some users may prefer to proceed in this manner exercising their own perception of relative risks. One risk is that the worker will fall from the ladder or have another form of accident (e.g. heart attack, ventilation problem, etc.) that requires that he or she be immediately rescued. Because the cable is not attached to the winch, there may be a delay in attaching the cable to the winch while the excess, i.e., “slack,” is wound before applying force to lift the worker upward. Because the winch is designed for lifting capability and not for speed in moving the cable, this may result in an undesirable delay in rescuing the worker. This problem can be mitigated by attaching a cleat 73 to the spool 68 of the winch as shown in FIG. 14. The cleat can be used to quickly and tightly engage the cable at any location on the cable. As soon as an alert is sounded to rescue the worker, the cable can be engaged by taking the shortest segment of cable between the winch and the worker who needs to be rescued, attaching the cable at that point (for example point 85 on the cable) to the cleat and engaging the winch so that rescue can commence immediately. FIG. 18 illustrates the engagement of the cable to the cleat and immediate commencement of rescue.

The details of one suitable cleat 73 are depicted in FIGS. 14A through 14D. The cleat includes a body 69 with one or more holes 70 for mounting the cleat (e.g., by nuts and bolts, rivets, etc.) to the spool 68 of a winch. The cleat contains an open groove 71 in which a rope can be placed length wise. Ribs 72 located in the groove lock the cable in the cleat so that the cable will not be removed by the normal rotation of the spool. The cable can only be inserted by forcing the cable into the groove from the top of the grove down. Once the cable is inserted into the groove, the ribs restrict movement of the cable along the length of the groove. The cable can be removed only by pulling it outward from the bottom of the grove to the top.

One particularly useful cleat that meets these requirements is a boat cleat marketed as Clamcleat® Model 115691 manufactured by Clamcleats Limited, Hertfords, United Kingdom and distributed in the United States by Sea-Dog Corporation, Everett Wash.

The cleat 73 can be mounted to the spool 68 as depicted in FIG. 14. In this case the mounting occurs on the side of the spool. However, the cleat can be mounted at any place on the spool where it can be readily accessed. Preferably, the mounting occurs on the outer portion of the spool rather than close to the access. The cleat is readily accessed there and movement of the handle on the winch results in the greatest movement of cable thereby facilitating rapid rescue.

The device of the present invention is generally stored and transported to the work site in the folded form shown in FIGS. 3 (base frame) and 8 (upper frame). The base portion is moved to the work area at the manhole and erected by unfolding side portions from the base. The base should be placed on a secure flat surface. The locking mechanism should then be engaged to provide structural integrity to the base and align the base for attachment of the top. If the surface is not flat, the adjustable feet should be employed by inserting one into the bottom of each post and then adjusting the height of each until the base portion is both stable and level.

The top portion is then moved to the work area and unfolded. A worker can then approach the open side of the base with the one leg of the upper section in hand. The worker can then slide the upper leg over the corner post of the lower guard. The worker can then walk around the system placing each leg of the upper section over the corresponding corner posts of the base. After all the legs and corner posts are in position, they should be locked into place by inserting the pins into the locking holes. The winch, cable, pulley and safety lanyard can then be installed.

As mentioned previously, the integral manhole guard and hoist of the present invention provides a number of advantages. Among other things, the combination of the base and upper portion and the use of a pyramid shape for the upper portion provide substantial height and clearance that minimizes obstruction of workers in and around the manhole. In addition, the pyramid shape for the upper portion provides load-bearing strength with the load being distributed concentrically and vertically to four major components of the manhole shield. When used as a fall arrest or retrieval system, the present invention is rated for 350 pounds. However, the structure itself may bear loads of up to approximately 1800 pounds.

All of these advantages can be achieved with a system that is light weight. The device can be separated into two segments that can be folded for storage and shipment. The base and upper portion can weigh as little as 24 pounds. The device can be moved on site and erected by a single worker.

One skilled in the art could make various alterations to the device as described herein without departing from the spirit of this invention. For example, it may be possible to use the upper portion of the device described herein with minor modifications to attach it to an existing stand-alone manhole guard. This could be done, for example, using brackets as previously described which connect the upper portion to the base. While the device will be operable in that configuration, it may not achieve the load bearing, fall arrest, stability and other safety characteristics associated with an integrated manhole guard and hoist system as described herein. As previously noted, many existing manhole guards are designed for portability and not for load bearing capacity.

1. A foldable hoist, fall-arrest and retrieval system to be used in connection with a rectangular manhole guard having vertical posts at the four corners of the guard and an opening for accessing a work area, comprising:
an upper structure having four elongated support members forming a pyramid shaped structure with an apex at the top, each support member comprising a base and a distal end with
the base of each of the support members being adapted for mounting to the corners of the manhole guard so that the apex is located over the manhole and
the distal ends of the support members being rotatable about the apex for folding so that the members are generally parallel for shipment and storage.
means connected at the apex for raising and lowering workers and/or cargo into and out of the manhole or for arresting the fall or recovering a worker.

2. The system of claim 1 in which the members and apex further contain stop means restraining rotation of the members beyond that needed to mount and deploy the system on the manhole guard.

3. The system of claim 1 in which the means for raising and lowering workers and/or cargo comprises a pulley and the system also includes a winch mounted to one of the members and a cable attached to the winch and to the worker and/or cargo via the pulley.

4. The system of claim 1 further comprising fall arrest means attached to the apex.

5. The system of claim 3 in which the winch contains a spool and a cleat attached to the spool for quick attachment of the cable in a manner so that the cable can be rotated about the spool.

6. The system of claim 5 in which the cleat comprises a boat cleat with an open groove for receipt of the cable and ribs located in the groove to restrain the cable in the cleat.

7. The system of claim 1 in which the two the members corresponding to the open side of the manhole guard are reinforced from the base upward.

8. A two piece foldable man-hole guard and fall arrest system comprising:
a base having three sides pivotally connected so that they can be folded into a parallel relation with one another for storage and shipment and that can be unfolded to form three sides of a rectangular guard surrounding a manhole and to define an open side for movement of personnel and materials;
an upper structure having four elongated support members forming a pyramid shaped structure with an apex at the top, each support member comprising a base and a distal end with
the base of each of the support members being adapted for mounting to the corners of the manhole guard so that the apex is located over the manhole and
the distal ends of the support members being rotatable about the apex for folding so that the members are generally parallel for shipment and storage; and.
means connected at the apex for raising and lowering workers and/or cargo into and out of the manhole or for arresting the fall or recovering a worker.

9. The system of claim 8 in which the base further comprises means for locking the three sides in the rectangular position.

10. The system of claim 8 in which the members and apex further contain stop means restraining rotation of the members beyond that needed to mount and deploy the system on the manhole guard.

11. The system of claim 8 in which the means for raising and lowering workers and/or cargo comprises a pulley and the system also includes a winch mounted to one of the members and a cable attached to the winch and to the worker and/or cargo via the pulley.

12. The system of claim 8 further comprising fall arrest means attached to the apex.

13. The system of claim 11 in which the winch contains a spool and the spool and a cleat attached to the spool for quick attachment of the cable so that the cable can be rotated about the spool.

14. The system of claim 13 in which the cleat comprises a boat cleat with an open groove for receipt of the cable and ribs located in the grove to lock the cable in the cleat.

15. The system of claim 8 in which the two members corresponding to the open side of the manhole guard are reinforced from the base upward.

16. The system of claim 8 further including adjustable means for horizontal leveling of the base.
